(19) United States
(12) Patent Application Publication
(10) Pub. No.: US 2005/0159126 A1
(43) Pub. Date: Jul. 21, 2005

(54) Apparatus and method of interruptible analog input

(76) Inventor: Chun-Hsiung Wang, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/035,740

(22) Filed: Jan. 18, 2005

(30) Foreign Application Priority Data
Jan. 16, 2004 (TW) 093101284

(51) Int. Cl. H04B 17/00

(52) U.S. Cl. 455/226.4

(57) ABSTRACT

The apparatus of interruptible analog input of the present invention includes: a plurality of resistors; a electronic signal detecting circuit used to detect the terminal electronic signal generated by the plurality of resistors and then generate a real-time signal when the terminal electronic signal changes; a analog-to-digital converter used to convert the terminal electronic signal into a digital format whenever the terminal electronic signal changes. The method of interruptible analog input of the present invention includes: detecting whether the terminal electronic signal of a plurality of resistors changes, if not, then executing the current proceeding process, else, determining whether interrupting the current proceeding process or not; if determining to interrupt, converting the changed terminal electronic signal into a digital format; finding the pressed key of a keyboard corresponding to the digital format via a lookup table and then executing the corresponding function of the pressed key.

### BACKGROUND OF THE INVENTION

1. Field of the Invention

The present invention relates to apparatus and method of analog input, and more particularly to apparatus and method of interruptible analog input.

2. Description of the Prior Art

As for the general electronic equipment concerned, no matter the household appliances for daily use or electronic entertainment equipment, the input keyboard of the electronic equipment is always needed to assist the user directly or indirectly in the control of the electronic equipment. There are two known input keyboard types: one is the digital input keyboard type and another is the analogy input keyboard type.

The generally seen digital input keyboard device 100 is shown in FIG. 1, the components of the digital input keyboard device 100 are arranged in a matrix which is made up of m-columns and n-rows. As shown in FIG. 1, each column and row crisscrosses to form a key, therefore, the m-columns and n-rows form m*n keys, and each key could be respectively indicated by a corresponding column and row. Accordingly, when a key which is corresponding to a certain column and row is pressed, the system can detect the pressed key according to the key-address thereof indicated by the corresponding column and row and then execute the corresponding function of the pressed key. The matrix of the digital input keyboard type is also called a digital matrix.

The generally seen analog input keyboard device 200 shown in FIG. 2 is a kind of analog circuit which is made up of a plurality of resistors connected in series. The analog input keyboard device 200 includes: a pull-up resistor Rᵢₙ, which one of its terminals is connected with a reference voltage V_{DD}, used to maintain the analog input keyboard device 200 in a stable voltage when no key is pressed; a plurality of divider resistors Rₜ(R₁,R₂, . . . R_{N}) connected together to the pull-up resistor Rᵢₙ respectively generating the voltage drop (V₁,V₂, . . . V_{N}), wherein each of the divider resistors (R₁,R₂, . . . R_{N}) is corresponding to a key of a keyboard and also each of the divider resistors (R₁,R₂, . . . R_{N}) is corresponding to a node (N₁,N₂, . . . N_{N}), moreover, the nodes (N₁,N₂, . . . N_{N}) are respectively connected to a corresponding switch controller (SW₁,SW₂, . . . SW_{N}), wherein while one key is pressed, the switch controller of the divider resistor corresponding to the pressed key will make its corresponding node shorting to ground; and a analog-to-digital converter (ADC) 210, which is connected to the node Nₜ between the pull-up resistor Rᵢₙ and the note N₁ of the divider resistors Rₜ, used to convert the sum of the voltage drops generated by the divider resistors Rₜ into a digital format. Additionally, in general, it is not a must for the analog input keyboard device to be assembled with the pull-up resistor Rᵢₙ.

Another generally seen analog input keyboard input device 300 shown in FIG. 3 is a kind of analog circuit which is made up of a plurality of resistors connected in parallel. The analog input keyboard device 300 includes: a pull-up resistor Rᵢₙ, which one of its terminals is connected with a reference voltage V_{DD}, used to maintain the analog input keyboard device 200 in a stable voltage when no key is pressed; a plurality of divider resistors Rₜ(R₁,R₂, . . . R_{N}) connected together to the pull-up resistor Rᵢₙ, wherein the currents which respectively flow through each of the divider resistors (R₁,R₂, . . . R_{N}) are respectively indicated as (I₁,I₂, . . . I_{N}) and each of the divider resistors (R₁,R₂, . . . R_{N}) is corresponding to a key and also each of the divider resistors (R₁,R₂, . . . R_{N}) is corresponding to a node (N₁,N₂, . . . N_{N}), moreover, each of the nodes (N₁,N₂, . . . N_{N}) is respectively connected to a corresponding switch controller (SW₁,SW₂, . . . SW_{N}), wherein when a key is pressed, the associated switch controller of the divider resistor corresponding to the pressed key will make its corresponding node become a open circuit; and a analog-to-digital converter (ADC) 310, which is connected to the node Nₜ between the pull-up resistor Rᵢₙ and the note N₁, used to convert the current change generated by the divider resistors Rₜ into a digital format.

Referring to FIG. 4, it shows a flow chart of the operation processes of the method of the analog input keyboard. The operation processes includes: first, transferring the terminal electronic signal of the node Nₜ into a digital format when the clock pulse of the system triggers the analog-to-digital converter 310 (process 410); finding the comparison value which is corresponding to the converted digital format via a lookup table (process 420); sequentially, detecting whether a key is pressed according to the comparison result via the lookup table (process 430), if no key is pressed, then back to the process 410, otherwise, if a key do be pressed; then executing the corresponding function of the pressed key and when the corresponding function has been accomplished, back to the process 410 again (process 440).

There are two generally known methods of detecting whether a key is pressed: one is the pooling method and the other is the interrupting method, the two methods are respectively described in detail below. As the pooling method concerned, it means that: the system detects whether a key is pressed for every periodical detecting time, wherein the periodical detecting time is controlled by a clock pulse signal of the system. The disadvantage of the pooling method is the system must detect whether a key is pressed constantly and if a key is pressed at the time that the triggering action of the clock pulse signal is not during the detecting time, the system may be unable to detect that the key is pressed or it must spend extra delay time to detect whether a key is pressed. Thus, the pooling method is time-consuming and less efficient. As the interrupting method concerned, it means that: the system continues executing the current proceeding operation process and interrupts the current proceeding operation process until a key is pressed, and then the system executes the corresponding function of the pressed key. Therefore, the interrupting method is more efficient and timesaving.

Accordingly aforementioned, the digital input keyboard device could employ both the pooling method and the interrupting method to detect whether a key is pressed, however, the analog input keyboard device could only employ the pooling method for detection. As the above-mentions, since the pooling method has some disadvantages, such as more time-consuming and less efficient, the digital input keyboard device usually employs the interrupting method to detect whether a key is pressed.

As the whole concerned, although the digital input keyboard device could employ the interrupting method which is more time-saving to detect whether a key is pressed, the array of the matrix of the digital input keyboard device always needs utilizing many pins, thus, the circuit configure of the digital input keyboard device occupies a larger space and that is inconvenient to expand the array of the matrix. On the contrary, since the analog input keyboard device is made up of a plurality of divider resistors connected together, it is more convenient and flexible for the analog input keyboard device to expand, moreover, the analog input keyboard device occupies less space. However, due to the fact that the analog input keyboard device could only employ the pooling method to detect whether a key is pressed, it will spend more time for inquiring, additionally, after every inquiring action, the system must convert the terminal voltage Vₜ into a digital format. Therefore, applying the analog input keyboard device consumes not only lots of time but also lots of electricity, and that is not convenient and economical for the electric products which take the electric power generated form a battery as the main energy.

Some portion of the above-mentioned related to the prior art of input keyboard device are referred from the Motorola semiconductor Application Note, “Expanding Digital Input with an A/D Convert”, by Brad Bierschenk, Motorola Applications Engineering, Austin, Tex.

### SUMMARY OF THE INVENTION

The invention provides an apparatus and method of interruptible analog input, which makes the input keyboard system employed in the present invention not only has the good expandable property of the analog input keyboard device but also can detect whether a key is pressed with a more time-saving and electricity-saving method.

The apparatus of interruptible analog input of the present invention includes: a plurality of divider resistors; a electronic signal detecting circuit used to detect whether a terminal electronic signal generated by the plurality of divider resistors changes and then generate a real-time signal while the terminal electronic signal changes; and a analog-to-digital converter used to convert the terminal electronic signal into a digital code while the terminal electronic signal changes. Moreover, the apparatus of the interruptible analog input could further include a pull-up resistance Rₜ used to stabilize the voltage of the apparatus of interruptible analog input.

The method of the interruptible analog input of the present invention includes: detecting whether the terminal electronic signal of a plurality of divider resistors changes; generating a real-time signal to notify the system to determine whether to interrupt the current proceeding process while the terminal electronic signal changes; converting the changed terminal electronic electronic signal into a digital code if the system determines to interrupt the current proceeding process; finding out the comparison value corresponding to the digital code via a lookup table to acquire what key is pressed; and then executing the corresponding function of the pressed key.

### BRIEF DESCRIPTION OF THE DRAWINGS

The objectives, features of the present invention as well as the advantages thereof can be best understood through the following preferred embodiments and the accompanying drawings, wherein:

FIG. 1 is a schematic drawing shows a conventional digital input keyboard device;

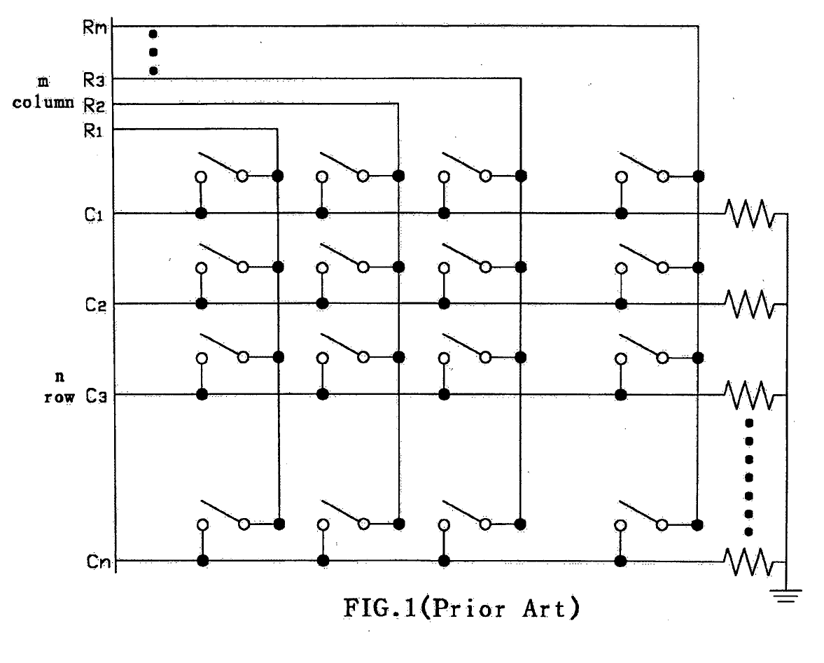

FIG. 2 is a schematic drawing shows a conventional analog input keyboard device with a plurality of divider resistors connected in serial;

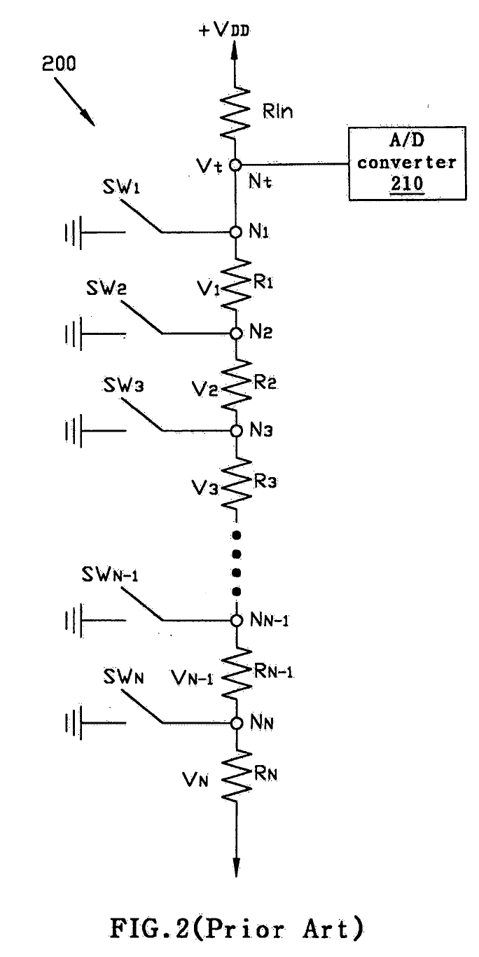

FIG. 3 is a schematic drawing shows a conventional analog input keyboard device with a plurality of divider resistors connected in parallel;

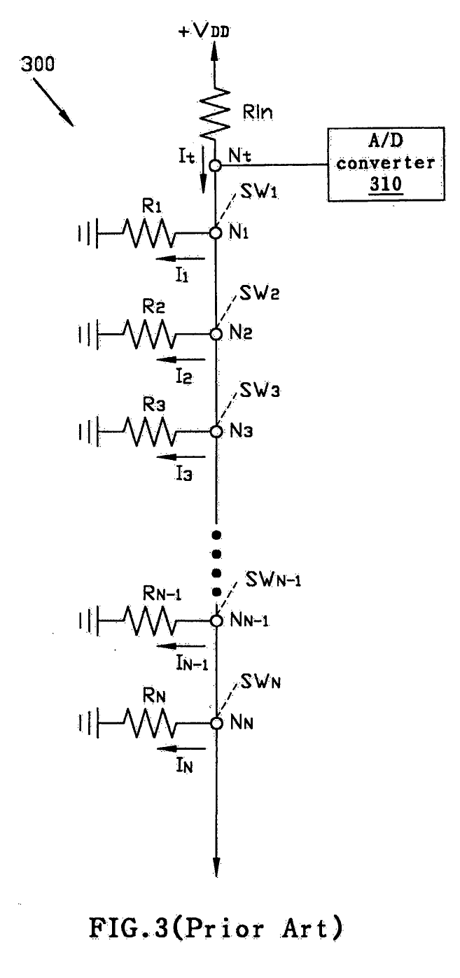

FIG. 4 is a flow chart of operation process of the conventional analog input;

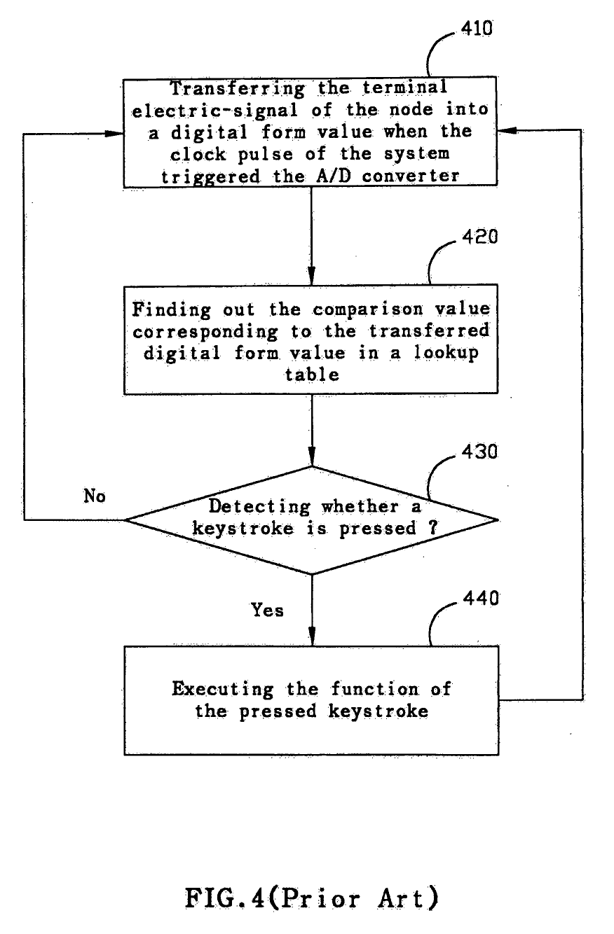

FIG. 5A is a schematic drawing shows the first preferred embodiment of the apparatus of interruptible analog input with a plurality of divider resistors connected in serial according the present invention;

FIG. 5B is a schematic drawing shows the second preferred embodiment of the apparatus of interruptible analog input with a plurality of divider resistors connected in serial according the present invention;

FIG. 5C is a schematic drawing shows the third preferred embodiment of the apparatus of interruptible analog input with a plurality of divider resistors connected in serial according the present invention;

FIG. 6A is a schematic drawing shows the fourth preferred embodiment of the apparatus of interruptible analog input with a plurality of divider resistors connected in parallel according the present invention;

FIG. 6B is a schematic drawing shows the fifth preferred embodiment of the apparatus of interruptible analog input with a plurality of divider resistors connected in parallel according the present invention;

FIG. 7 is a flow chart of operation process of the method of interruptible analog input according to the present invention;

### DESCRIPTION OF THE PREFERRED EMBODIMENT

The invention provides an apparatus and method of interruptible analog input, which makes the keyboard system employing the present apparatus and method not only has a good expandable property of the analog input keyboard but also can detect whether a key is pressed with a more time-saving and electricity-saving way. Several preferred embodiments will be described below for explaining and understanding the invention more clearly, however they are only for example, not intended to limit the scope of the invention. Thus, many equal variations and modifications of the following embodiments could be made without departing form the spirit of the present invention should be covered by the following claims.

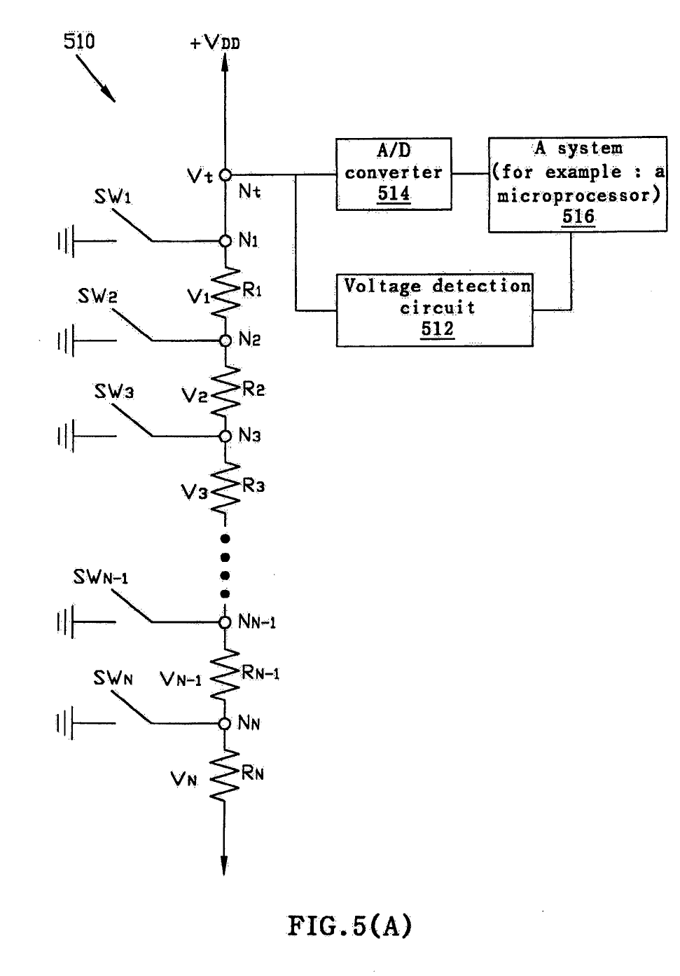

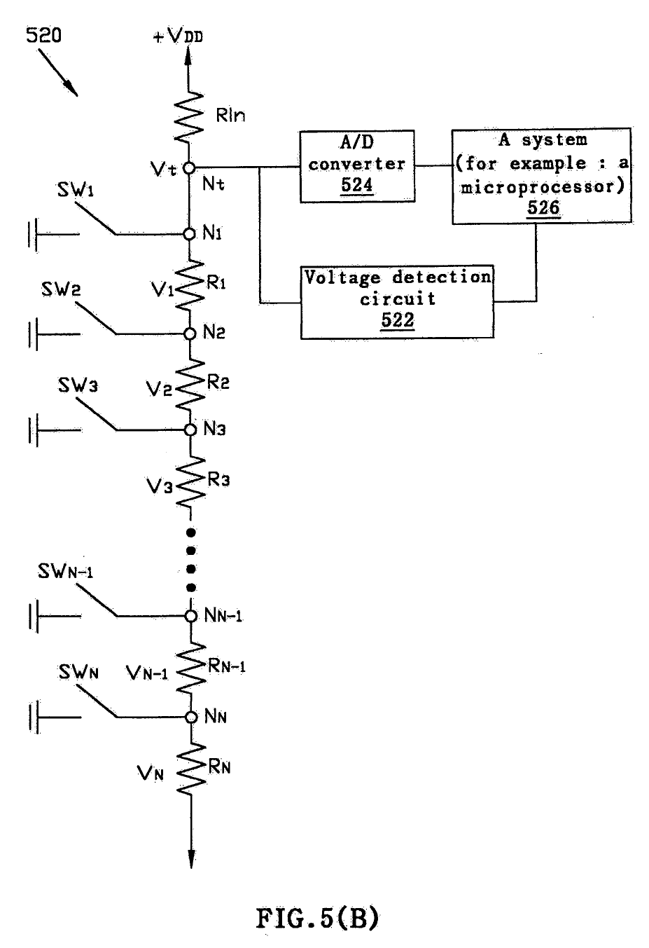

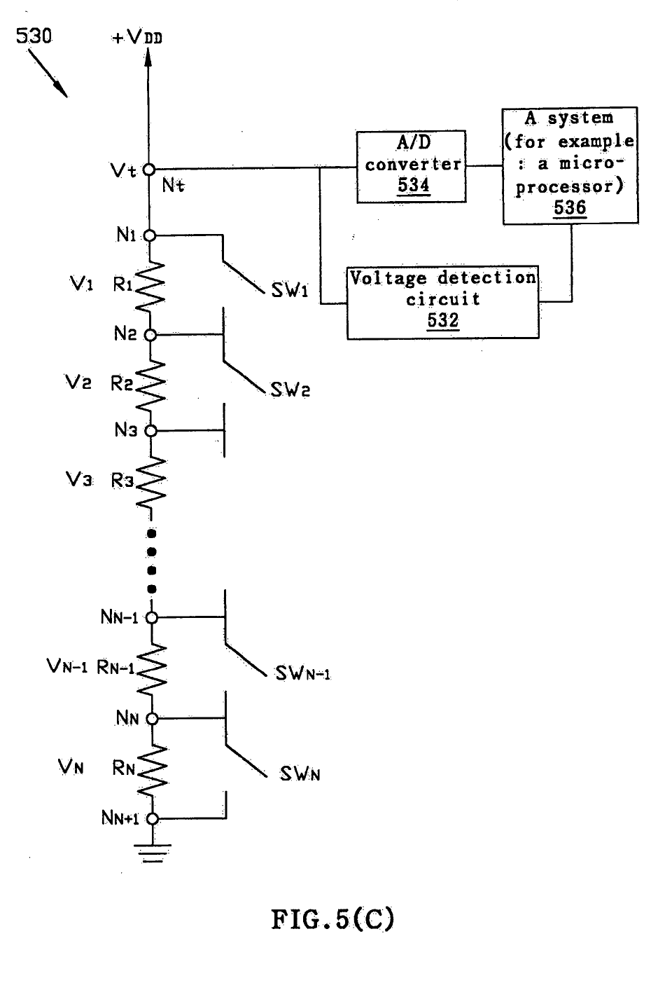

The first preferred embodiment of the apparatus of interruptible analog input according to the present invention is shown as FIG. 5A, it includes: a plurality of divider resistors Rₜ(R₁,R₂, . . . R_{N}) connected in series and connected together to a reference voltage V_{DD} respectively generating the voltage drop (V₁,V₂, . . . V_{N}), wherein the front terminal of each of the divider resistors (R₁,R₂, . . . R_{N}) is respectively corresponding to nodes (N₁,N₂, . . . N_{N}) and each of the divider resistors (R₁,R₂, . . . R_{N}) is corresponding to a key of a keyboard. The total number of the divider resistors (R₁,R₂, . . . R_{N}) is not limited, it can be increased or decreased according to the actual requirement. Additionally, each of the nodes (N₁,N₂, . . . N_{N}) is correspondingly connected to a switch controller (SW₁,SW₂, . . . SW_{N}), wherein the divider resistors (R₁,R₂, . . . R_{N}) could have the same resistor value, or have different value, or partly have the same resistor value and partly have different resistor value; a voltage detecting circuit 512 connected to the node Nₜ between the divider resistors Rₜ (R₁,R₂, . . . R_{N}) and the reference V_{DD} used to detect whether the potential of terminal voltage Vₜ at the node Nₜ changes and generate a real-time signal, wherein the terminal voltage Vₜ is just the sum of the voltage drops generated by the plurality of the divider resistors (R₁,R₂, . . . R_{N}); a analog-to-digital converter (ADC) 514, which is also connected to the node Nₜ between the divider resistors Rₜ(R₁,R₂, . . . R_{N}) and the reference voltage Vₜ, used to convert the terminal voltage Vₜ into a digital format while the voltage detecting circuit 512 detects that the potential of the terminal voltage Vₜ changes; and a system 516 for receiving the real-time signal generated form the voltage detecting circuit 512 and determining whether to interrupt the current proceeding process after receiving the real-time signal, wherein the system 516 is broadly referred to the general control mechanism which could be applied in the associated field according to the present invention, for example, if the invention is applied in a computer, the system 516 is referred to a microprocessor.

As shown in FIG. 5A, if the plurality of the divider resistors Rₜ(R₁,R₂, . . . R_{N}) are connected in series, each of the switch controllers (SW₁,SW₂, . . . SW_{N}) is correspondingly connected to one of the nodes (N₁,N₂, . . . N_{N}) at the front terminal of the divider resistors (R₁,R₂, . . . R_{N}) by way of an open circuit; and while a key is pressed, one of the switch controllers (SW₁,SW₂, . . . SW_{N}) corresponding to the pressed key would be connected to create a short circuit to the ground and thereby the terminal voltage Vₜ is changed.

Besides, as the FIG. 5B shown, the second preferred embodiment of the apparatus of interruptible analog input 520 according to the present invention further includes a pull-up resistance Rᵢₙ which is inserted between the node Nₜ and the V_{DD} used to stabilize the voltage.

Referring to FIG. 5A and FIG. 5B, although the switch controllers (SW₁,SW₂, . . . SW_{N}) are respectively connected to the front terminal of the corresponding divider resistors (R₁,R₂, . . . R_{N}), the connecting location of each of the switch controllers (SW₁,SW₂, . . . SW_{N}) is not limited to be in the front terminal of the corresponding divider resistors (R₁,R₂, . . . R_{N}), any other connecting locations, which can make the sum of voltage drops of the divider resistors (R₁,R₂, . . . R_{N}) change when one of the switch controllers (SW₁,SW₂, . . . SW_{N}) is pressed, should be covered by the scope of the present invention. For instance, the switch controllers (SW₁,SW₂, . . . SW_{N}) could be respectively connected to the back terminal of the corresponding divider resistors (R₁,R₂, . . . R_{N}), namely, the first switch controller SW₁ is connected to the back terminal of the divider resistor R₁ (i.e. the position of the node N₂ in FIG. 5A or in FIG. 5B) and the rest may be deduced by analogy.

Furthermore, the third preferred embodiment of the apparatus of interruptible analog input 530 according to the invention is shown as FIG. 5C. In the third preferred embodiment, each of the switch controllers (SW₁,SW₂, . . . SW_{N}) is correspondingly connected between two adjacent nodes of the corresponding divider resistor by the way of an open circuit (for example, the switch SW₁ is connected between the two nodes N₁-N₂, the switch SW₂ is connected between the two nodes N₂-N₃ . . . , and SW_{N} is connected between the two nodes N_{N}-N_{N+1} by the way of an open circuit). While one key is pressed, the switch controller corresponding to the pressed key makes the channel between the associated two adjacent nodes be shorted to make the sum of the voltage drops of the divider resistor Rₜ(R₁,R₂, . . . R_{N}) change, thereby, the potential of the terminal voltage Vₜ is changed. Accordingly the aforementioned, the third embodiment employs the method that making the channel between the two adjacent nodes at both terminals of the corresponding divider resistor be a short circuit instead of making the circuit of the switch controller directly be shorted to ground as shown in the first and the second embodiments. Thus, the third embodiment could be applied in the situation that more than one key are pressed at the same time. Besides, the third embodiment of the apparatus of interruptible analog input 530 also could further include a pull-up resistance (not shown) used to stabilize the voltage.

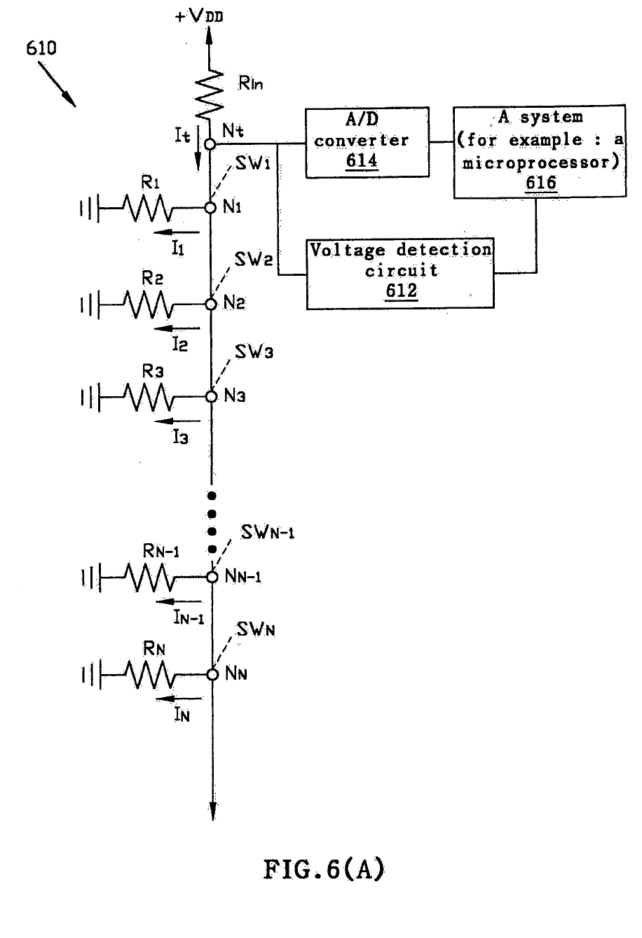

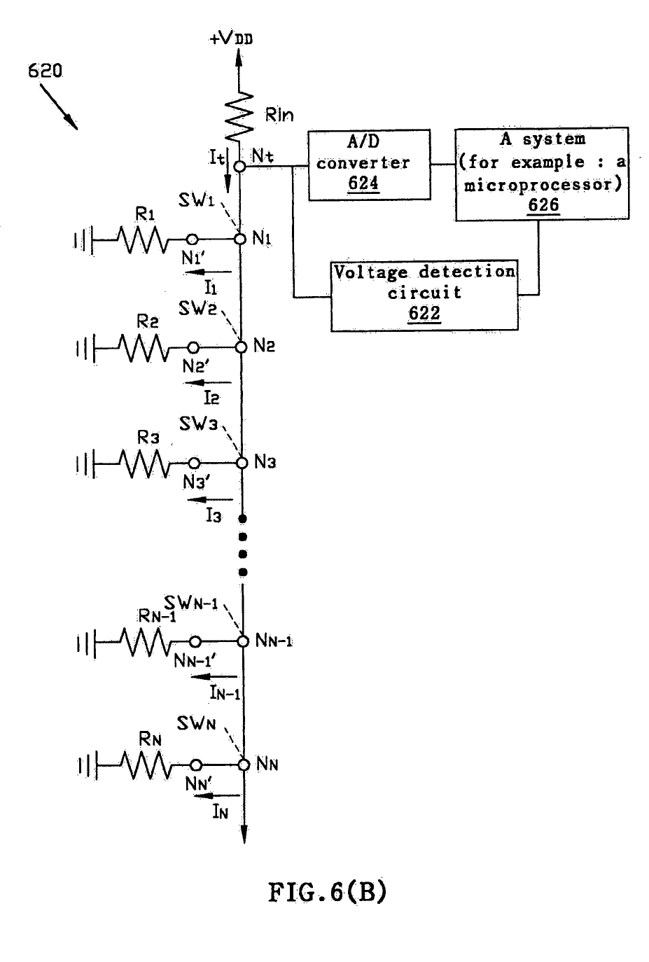

The fourth embodiment of the apparatus of interruptible analog input according to the invention is shown as FIG. 6A. The interruptible analog input apparatus 610 includes: a plurality of divider resistors Rₜ(R₁,R₂, . . . R_{N}) connected in parallel and connected together to a reference voltage V_{DD}, wherein the currents which respectively flow through the divider resistors (R₁,R₂, . . . R_{N}) are respectively indicated as (I₁,I₂, . . . I_{N}) and each of the divider resistors (R₁,R₂, . . . R_{N}) is corresponding to a key. The total number of the divider resistors (R₁,R₂, . . . R_{N}) is not limited and can be increased and decreased according to the actual requirement. Additionally, each of the nodes (N₁,N₂, . . . N_{N}) corresponding to the divider resistors (R₁,R₂, . . . R_{N}) is correspondingly connected to one of the switch controllers (SW₁,SW₂, . . . SW_{N}), wherein the divider resistors (R₁,R₂, . . . R_{N}) could have the same resistor value, or have different resistor value, or partly have the same resistor value and partly have different resistor value; a pull-up resistor Rᵢₙ inserted between the node Nₜ and the reference voltage V_{DD}, is used to stabilize the voltage of the system; a current detecting circuit 612 connected to the node Nₜ between the divider resistors Rₜ and the pull-up resistor Rᵢₙ used to detect whether the potential of terminal current Iₜ of the node Nₜ changes and then generate a real-time signal, wherein the terminal current Iₜ is the sum of the currents which respectively flow through the plurality of the divider resistors Rₜ; a analog-to-digital convert (ADC) 614 also connected to the node Nₜ between the divider resistors Rₜ and the pull-up resistor Rᵢₙ used to convert the terminal current Iₜ into a digital format while the current detecting circuit 612 detects that the potential of the terminal current Iₜ changes; and a system 616 receiving the real-time signal generated from the current detecting circuit 612 used to determine whether to interrupt the proceeding process after receiving the real-time signal, wherein the system 616 is broadly referred to the general control mechanism which can be applied in the associated field of the present invention, for example, if the present invention is applied in a computer, the system 616 is referred to a microprocessor.

As shown in FIG. 6A, the plurality of the divider resistors Rₜ(R₁,R₂, . . . R_{N}) are connected in parallel, and the switch controllers (SW₁,SW₂, . . . SW_{N}) corresponding to the divider resistors (R₁,R₂, . . . R_{N}) are respectively connected between two adjacent nodes of the nodes (N₁,N₂, . . . N_{N}) by way of an short circuit; and when a key is pressed, one of the switch controllers (SW₁,SW₂, . . . SW_{N}) corresponding to the pressed key would make the channel between the two adjacent nodes of the corresponding two adjacent divider resistors be a open circuit to make the sum of the resistance of the divider resistors change and then the terminal current Iₜ is changed.

Referring to FIG. 6A, although each of the switch controllers (SW₁,SW₂, . . . SW_{N}) is correspondingly connected between two adjacent nodes of the nodes (N₁,N₂, . . . N_{N}) which are respectively corresponding to a first divider resistor of the divider resistors (R₁,R₂, . . . R_{N}) and a second divider resistor of the divider resistors (R₁,R₂, . . . R_{N}) forward the first divider resistor (for example, the switch SW₁ is connected between the two nodes Nₜ-N₁, the switch SW₂ is connected between the two nodes N₁-N₂ . . . , and SW_{N} is connected between the two adjacent nodes N_{N-1}-N_{N}), in fact, the connecting locations of the switch controllers (SW₁,SW₂, . . . SW_{N}) are not limited to be in the above-mentioned location, any other connecting locations, which can make the sum of the currents of the divider resistors (R₁,R₂, . . . R_{N}) change when any one of the switch controllers (SW₁,SW₂, . . . SW_{N}) is pressed, should be covered by the scope of the present invention. For instance, the switch controllers (SW₁,SW₂, . . . SW_{N}) could be respectively connected between two adjacent nodes of the nodes (N₁,N₂, . . . N_{N}) which are respectively corresponding to a first divider resistor of the divider resistors (R₁,R₂, . . . R_{N}) and a second divider resistor of the divider resistors (R₁,R₂, . . . R_{N}) backward the first divider resistor, namely, the first switch controller SW₁ is connected between the node N₁ of the first divider resistor R₁ and the node N₂ of the second divider resistance R₂ and the rest may be deduced by analogy.

Furthermore, the fifth preferred embodiment of the apparatus interruptible analog input 620 according to the invention is shown as FIG. 6B. In the fifth preferred embodiment, each of the switch controllers (SW₁,SW₂, . . . SW_{N}) is connected between two adjacent nodes, such as (N₁-N₁′), (N₂-N₂′) . . . , or (N_{N}-N_{N}′), corresponding to one of the divider resistors by the way of a short circuit. When a key is pressed, the switch controller corresponding to the pressed key will make the channel between the associated two adjacent nodes be a open circuit to cause the total resistance of the divider resistors Rₜ (R₁,R₂, . . . R_{N}) to change, thereby, the potential of terminal current Iₜ is changed. Accordingly the aforementioned, the fifth embodiment employs the artifice that makes the channel between the two adjacent nodes of one corresponding divider resistor be a short circuit instead of employing the artifice as shown in the fourth embodiment that directly makes the channel between the two adjacent nodes of two corresponding adjacent divider resistor be a short circuit. Thus, the fifth embodiment could be applied for the situation that more than one key is pressed at the same time.

As within the aforementioned descriptions, in the apparatus of interruptible analog input according to the present invention, the plurality of divider resistors Rₜ(R₁,R₂, . . . R_{N}) could be connected in series (as shown in the FIG. 5A, FIG. 5B and FIG. 5C) or be connected in parallel (as shown in the FIG. 6A, FIG. 6B and FIG. 6C) or connected partly in series and partly in parallel (not shown).

Taking the apparatus of interruptible analog input of the present invention which the divider resistors thereof are connected in series for example, the method of interruptible analog input according to the invention includes: first, the voltage detecting circuit (512,522 or 532) detects whether the terminal voltage Vₜ changes, if the terminal voltage Vₜ does not change, the system (516,526 or 536) continues executing the current proceeding process, if the terminal voltage Vₜ changes, the real-time signal generated from the voltage detecting circuit (512,522 or 532) will cause the system (516,526 or 536) to determine whether to interrupt the current proceeding process. Then, if the system (516,526 or 536) does not determine to interrupt the current proceeding process, the system (516,526 or 536) continues executing the original proceeding process; otherwise, the system (516,526 or 536) interrupts the current proceeding process and converts the changed terminal voltage Vₜ into a digital format through the analog-to-digital conversion (514,524 or 534), sequentially, finding a comparison value corresponding to the digital format of the terminal voltage Vₜ via a lookup table to acquire what key is pressed. Following, the system (516,526 or 536) executes the corresponding function of the pressed key.

If the method of interruptible analog input according to the present invention is applied in the embodiment which the divider resistors Rₜ(R₁,R₂, . . . R_{N}) thereof are connected in parallel, the operation process of the method of interruptible analog input is proceeded by that the detecting circuit (612, 622) will detect whether the terminal current Iₜ changes, if so, the system will convert the changed current Iₜ into a digital format through the analog-to-digital converter (614,624) and the following process are identical as the aforementioned embodiments which the plurality of divider resistor Rₜ(R₁,R₂, . . . R_{N}) thereof are connected in series.

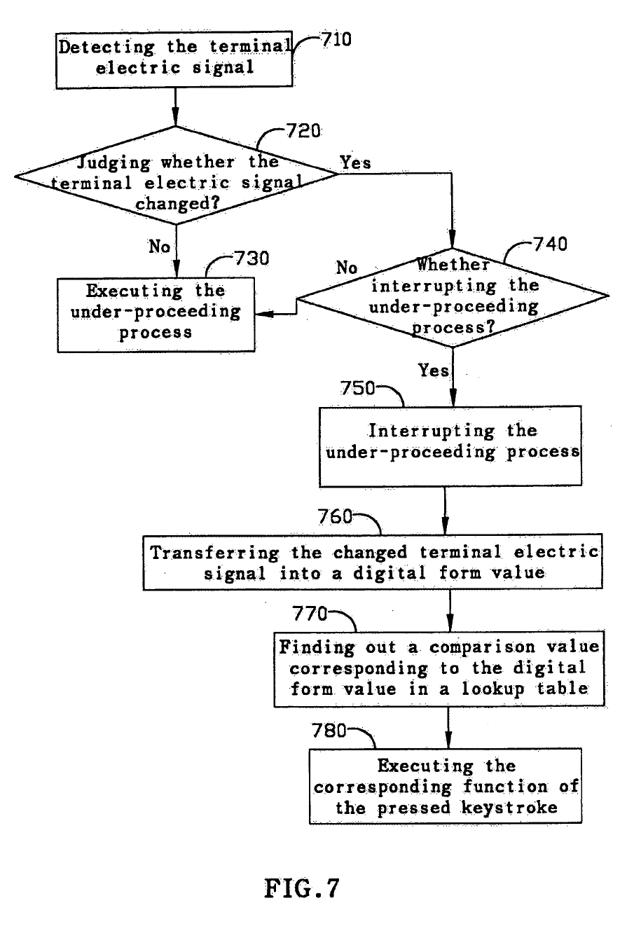

Referring to the FIG. 7, it shows a flow chart of the operation processes of the method of the interruptible analog input according to the present invention. The operation processes includes: detecting the terminals electronic signal (process 710); determining whether the terminals electronic signal changes (process 720), if not, the system continues executing the current proceeding process (process 730), otherwise, if the signal changes, the system determines whether to interrupt the current proceeding process (process 740); if so, the system interrupts the current proceeding process (process 750), if not, it goes back to the process 730; following the process 750, converting the changed the terminals electronic signal into a digital format (process 760); sequentially finding a comparison value via a lookup table corresponding to the digital format (process 770); and then executing the corresponding function of the pressed key. In the above-mentioned embodiment according to FIG. 7, if the plurality of the divider resistors Rₜ(R₁,R₂, . . . R_{N}) are connected in series, the system detects the terminal voltage Vₜ at the node Nₜ; otherwise, if the divider resistors Rₜ(R₁,R₂, . . . R_{N}) are connected in parallel, the system detects the terminal current Iₜ at the node Nₜ; further, if the divider resistors Rₜ(R₁,R₂, . . . R_{N}) are partly connected in serial and partly connected in parallel, the system detects both the terminal voltage Vₜ and the terminal current Iₜ of the node Nₜ at the same time.

Taking an embodiment which its plurality of divider resistors are connected in series for example (corresponding to the FIG. 5A or FIG. 5B), when presses no key, the terminal voltage value is Vₜ(=V₁+V₂ . . . +V_{N}); and when a key K (respectively corresponding to the divider resistor R_{K} and the switch controller SW_{K} connected with the node N_{K}) has been pressed, the node N_{K} wound be shorted to ground and the terminal voltage value becomes to Vₜ′(=V₁+V₂ . . . +V_{K-1}) (K≦N), (assuming the disposed positions of the switch controllers (SW₁,SW₂, . . . SW_{N}) are as shown in FIG. 5A or the FIG. 5B). At this time, the voltage detecting circuit (512,524) detects that the terminal voltage Vt′ is smaller than the original terminal voltage Vₜ, namely, the voltage potential changed, therefore, a real-time signal is sent to notify the system (516,526) that the terminal voltage changed. If the system (516,526) determines not to interrupt the current proceeding process, the current proceeding process is going on, otherwise, the system (516,526) interrupts the current proceeding process and then the analog-to-digital converter (516,524) converts the changed terminal voltage Vₜ′(=Vₗ+V₂ . . . +V_{K-1}) into a digital format. Following, a comparison value corresponding to the terminal voltage Vₜ′(=V₁+V₂ . . . +V_{K-1}) is found via a lookup table to acquire what key is pressed. Finally, the corresponding function of the pressed key is executed.

Taking an another embodiment which its plurality of divider resistors are connected in series (corresponding to FIG. 5C) for example, when no key is pressed, the terminal voltage value is Vₜ(=Vₗ+V₂ . . . +V_{N}); and while two keys respectively named as the key K and key J, which are respectively corresponding to the divider resistors R_{K} and R_{J} as well as to the switch controllers SW_{K} and SW_{J} respectively connected between the node N_{K} and the node N_{K+1} as well as the node N_{J} and the node N_{J+1}, are both pressed at the same time, the channels between the two nodes N_{K}-N_{K+1} and the two nodes N_{J}-N_{J+1} will respectively become a short circuit and the terminal voltage value becomes to Vₜ′{(=V₁+V₂ . . . +V_{K-1})−(V_{K}+V_{J})}. At this time, the voltage detecting circuit 532 detectes that the terminal Vₜ′ is smaller than the original terminal voltage Vₜ, namely, the voltage potential changed, therefore, a real-time signal is sent to notify the system 536 that the terminal voltage changed. Sequentially, if the system 536 determines not to interrupt the current proceeding process, the proceeding process is going on, otherwise, the system 536 interrupts the current proceeding process and then the analog-to-digital converter 534 converts the changed terminal voltage Vₜ′{(=V₁+V₂ . . . +V_{K-1})−(V_{K}+V_{J})} into a digital format. Following, a comparison value corresponding to the terminal voltage Vₜ′{(=V₁+V₂ . . . +V_{K-1})−(V_{K}+V_{J})} is found via a lookup table to acquire what key is pressed. Finally, the corresponding function of the pressed key is executed.

Taking yet another embodiment which its plurality of divider resistors are connected in parallel (corresponding to FIG. 6A) for example, when no key is pressed, the terminal current value is Iₜ(=I₁+I₂ . . . +I_{N}); and when a key K (respectively corresponding to the divider resistor R_{K} and to the switch controller SW_{K} connected between the two nodes N_{K-1}-N_{K}) is pressed, the channel between the node N_{K} and the node N_{K-1} would be an open circuit and the terminal current value becomes to Iₜ′(=I₁+I₂ . . . +I_{K-1})(K≦N), assuming the disposed positions of the switch controllers (SW₁,SW₂, . . . SW_{N}) are as shown in FIG. 6A. At this time, the current detecting circuit 612 detectes that the terminal voltage Iₜ′ is smaller than the original terminal current Iₜ, namely, the current potential is changed, therefore, a real-time signal is sent to notify the system 616 that the terminal current changed. If the system 616 determines not to interrupt the current proceeding process, the current proceeding process is going on, otherwise, the system 616 interrupts the current proceeding process and then the analog-to-digital converter 614 converts the changed terminal voltage Iₜ′(=I₁+I₂ . . . +I_{K-1}) into a digital format. Following, a comparison value corresponding to the terminal current Iₜ′(=I₁+I₂ . . . +I_{K-1}) is found via a lookup table to acquire what key is pressed. Finally, the corresponding function of the pressed key is executed.

Taking further another embodiment which its plurality of divider resistors are connected in parallel (corresponding to FIG. 6B) for example, when no key is pressed, the terminal current value is Iₜ(=I₁+I₂ . . . +I_{N}); and when two keys respectively named the key K and key J, which are respectively corresponding to the divider resistors R_{K} and R_{J} as well as to the switch controllers SW_{K} and SW_{J} respectively connected between the two nodes N_{K}-N_{K}′ and the two nodes N_{J}-N_{J}′, are both pressed at the same time, the two channels between the two nodes N_{K}-N_{K}′ and the two nodes N_{J}-N_{J}′ will respectively become a short circuit and the terminal current value becomes to Iₜ′{(=I₁+I₂ . . . +I_{N})−(I_{K}+I_{J})}. At this time, the current detecting circuit 622 detectes that the terminal current Iₜ′ is smaller than the original terminal current Iₜ, namely, the current potential changes, therefore, a real-time signal is sent to notify the system 626 that the terminal current changed. Sequentially, if the system 626 determines not to interrupt the proceeding process, the proceeding process is going on, otherwise, the system 626 interrupts the proceeding process and then the analog-to-digital converter 624 converts the changed terminal voltage Iₜ′{(=I₁+I₂ . . . +I_{N})−(I_{K}+I_{J})} into a digital format. Following, a comparison value corresponding to the terminal current Iₜ′{(=I₁+I₂ . . . +I_{N})−(I_{K}+I_{J})} is found via a lookup table to acquire what key is pressed. Finally, the corresponding function of the pressed key is executed.

Accordingly in the aforementioned, as the dimension and expansibility of the input keyboard device is concerned, the general prior art of the input keyboard devices usually employs the analog input method. However, by the analog input, the system can only adopt the inquiring method to detect whether a key is pressed and such that is time-consuming and non-efficient.

The present invention provides an apparatus and method of interruptible analog input, which not only makes use of the characters with more expandability and less space-consuming of the analog input but also enables the analog input device detect whether a key is pressed via an interruptible method to overcome the time-consuming problem of the inquiring method, and moreover, resolve the electricity-consuming problem created by the requirement of the general analog input method that must transfer the terminal voltage into a digital code for every periodical detecting time.

Among the above-mentioned preferred embodiments of the present invention, some conditions have been taken into consideration, such as the plurality of divider resistors which are connected in series; one key is pressed or two keys are pressed at the same; and the different disposed locations of the switch controllers, however, all that are not intended to limit the spirit and the scope of the invention. Thus, many other conditions, such as the plurality of divider resistors are connected in parallel, more than two keys are pressed, or any other disposed locations of the switch controllers which can make the sum of the resistance of the divider resistors change, should be covered by the spirit of the present invention. Therefore, many equal variations and modifications of the aforementioned embodiments could be made without departing form the spirit of the present invention should be covered by the following claims.

1. A apparatus of interruptible analog input, comprising:
a plurality of resistors connected together to a reference voltage, each of said resistors having an associated voltage drop;
a detecting circuit connected to a node between said reference voltage and said plurality of resistors for detecting an electronic signal at said node; and
a analog-to-digital converter connected to said node between said reference voltage and said plurality of resistors, for converting the electronic-signal of said node into a corresponding digital code;
wherein said analog-to-digital converter performs the conversion whenever the electronic signal of said node changes.

2. The apparatus according to claim 1, further comprising a pull-up resistor inserted between said node and said reference voltage, for stabilizing said apparatus.

3. The apparatus according to claim 1, wherein said plurality of resistors are connected in series, or parallel, or partly in series and partly in parallel.

4. The apparatus according to claim 3, wherein said detecting circuit acts as a voltage detecting circuit for detecting the variation voltage at said node, in case said plurality of resistors are connected in series.

5. The apparatus according to claim 3, wherein said detecting circuit acts as a current detecting circuit for detecting the current variation through said node, in case said plurality of resistors are connected in parallel.

6. The apparatus according to claim 3, wherein said detecting circuit acts as a combined voltage-current detecting circuit for detecting voltage and current variation of said node, in case said plurality of resistors are partly connected in series and partly connected in parallel.

7. The apparatus according to claim 1, wherein said plurality of resistors have same resistor value, or have different resistor value, or partly have same resistor value and partly have different resistor value.

8. The apparatus according to claim 1, wherein value of said electronic signal at said node is equal to sum of value of associated electronic signal generated by said resistors.

9. The apparatus according to claim 1, further comprising a plurality of switches each corresponding to one of said plurality of resistors.

10. The apparatus according to claim 9, wherein said plurality of resistors are connected in series, and each of said switches is correspondingly opening connected between a node of one of said resistor and a ground, so that the node of the resistor is shorted to the ground while the associated switch is pressed.

11. The apparatus according to claim 9, wherein said plurality of resistors are connected in parallel, each of said plurality of switches is correspondingly shorting connected between two of the adjacent resistors, so that the adjacent resistors are disconnected (by way of an open circuit) while the associated switch is pressed.

12. The apparatus according to claim 9, wherein said plurality of resistors are partly connected in series and partly connected in parallel, and each of a portion of said switches corresponding to the resistors connected in series is correspondingly opening connected between a node of one of the resistors and a ground, so that the node of the resistor is shorted to the ground while the associated switch is pressed, and each of the other portion of said switches corresponding to the resistors connected in parallel is correspondingly shorting connected between two of the adjacent resistors, so that the adjacent resistors are disconnected while the associated switch is pressed.

13. The apparatus according to claim 9, wherein said plurality of resistors are connected in series, and each of said switches is correspondingly connected across two nodes of two of the adjacent resistors by way of open circuit, so that the two nodes are shorted while the associated switch is pressed.

14. The apparatus according to claim 9, wherein said plurality of resistors are connected in parallel, and each of said switches is correspondingly connected across one of said resistors by way of short circuit, so that two nodes of the resistor are disconnected while the associated switch is pressed.

15. The apparatus according to claim 9, wherein said plurality of resistors are partly connected in series and partly connected in parallel, and each of a portion of said switches corresponding to the resistors connected in series is correspondingly connected across two nodes of two of the adjacent resistors by way of open circuit, so that the two nodes are shorted while the associated switch is pressed, and each of the other portion of said switches corresponding to the resistors connected in parallel is correspondingly connected across one of the resistors by way of short circuit, so that two nodes of the resistor are disconnected while the associated switch is pressed.

16. The apparatus according to claim 1, wherein said apparatus is further adapted to a keyboard, such that number of said resistors is equal to number of keys of said keyboard.

17. A method of interruptible analog input, comprising:
detecting an electronic signal at a node among a plurality of resistors, which are connected together to a reference voltage;
converting the electronic signal of said node into a digital format; and
finding out a corresponding function according to said digital format via a lookup table;
wherein the conversion is performed whenever the electronic signal of said node changes according to an input, and thereafter a system is notified.

18. The method according to claim 17, wherein said plurality of resistors are connected in series, or in parallel, or partly in series and partly in parallel.

19. The method according to claim 18, wherein said electronic signal is a voltage signal, in case said plurality of resistors are connected in series.

20. The method according to claim 18, wherein said electronic signal is a current signal, in case said plurality of resistors are connected in parallel.

21. The method according to claim 18, wherein said electronic signal is a combined voltage-current signal, in case said plurality of resistors are partly connected in series and partly connected in parallel.

22. The method according to claim 17, wherein said plurality of resistors have same resistor value, or have different resistor value, or partly have same resistor value and partly have different resistor value.

23. The method according to claim 17, further comprising interrupting the proceeding process whenever the electronic signal of said node changes.

24. The method according to claim 17, further comprising continuing the proceeding process when the electronic signal of said node changes.

25. The method according to claim 17, further comprising finding out the corresponding function according to said digital format via a lookup table and executing said corresponding function.

26. The method according to claim 17, wherein said method is further adapted to a keyboard, such that number of said resistors is equal to number of keys of said keyboard.
